(19) United States
(12) Patent Application Publication
(10) Pub. No.: US 2016/0059522 A1
(43) Pub. Date: Mar. 3, 2016

(54) MULTILAYER LAMINATE FOR TIRES

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: MARC GREIVELDINGER, Clermont-Ferrand (FR); CATHERINE GAUTHIER, Clermont-Ferrand (FR); AURELIE TRIGUEL, Clermont-Ferrand (FR)

(21) Appl. No.: 14/778,347

(22) PCT Filed: Mar. 6, 2014
(86) PCT No.: PCT/EP2014/054371

§ 371 Date: Sep. 18, 2015

(30) Foreign Application Priority Data
Mar. 22, 2013 (FR) 1352560

(51) Int. Cl. B32B 25/04; B32B 25/16; B32B 25/02

(52) U.S. Cl. CPC B32B 25/042; B32B 25/02; B32B 25/16; B32B 2274/00; B32B 2307/7242; B32B 2605/08

(57) ABSTRACT

An airtight elastomeric laminate for tires comprises at least two superimposed layers of elastomer The first layer, includes at least a thermoplastic block elastomer comprising at least one central polyisobutylene block and adjacent blocks composed of at least one polymerized monomer, other than a styrene monomer, and on a plasticizing system. At least 5 phr of the thermoplastic elastomer present in the second layer are compatible with at least 5 phr of the thermoplastic block elastomer present in the first layer.

The present invention relates to laminates for tyres comprising an airtight composition, the elastomers of which are predominantly thermoplastic block elastomers comprising at least one central polyisobutylene block and adjacent blocks composed of at least one polymerized monomer, other than a styrene monomer, in one of their elastomeric layers.

In a conventional tyre, the various elastomeric layers are composed of diene elastomer compositions, adhering to one another via bonds created during the crosslinking of the said elastomers. These layers thus have to be combined before the curing (or the crosslinking) in order to allow them to adhere.

It is advantageous today for tyre manufacturers to use airtight elastomeric layers comprising, as elastomers, predominantly thermoplastic block elastomers comprising at least one central polyisobutylene block and adjacent blocks composed of at least one polymerized monomer, other than a styrene monomer, in order to benefit from the properties of these elastomers, in particular for the airtightness, the reduction in the rolling resistance and the processability.

The difficulty in the use of such layers, the elastomers of which are predominantly thermoplastic elastomers (TPEs), in particular thermoplastic block elastomers, comprising at least one central polyisobutylene block and adjacent blocks composed of at least one polymerized monomer, other than a styrene monomer, is their adhesion to the adjacent diene layers of conventional composition, this being before the curing of the resulting laminate or after the curing of the layer adjacent to the layer, the elastomers of which are predominantly thermoplastic block elastomers comprising at least one central polyisobutylene block and adjacent blocks composed of at least one polymerized monomer, other than a styrene monomer.

The Applicant Companies have previously described airtight layers for tyres comprising a layer, the elastomers of which are predominantly thermoplastic block elastomers comprising at least one central polyisobutylene block and adjacent blocks composed of at least one polymerized monomer, other than a styrene monomer, for example in the document WO2011/131560. In this document, an airtight layer is described, without there being indicated a laminate composed of this airtight layer and of a second diene layer, and exhibiting good adhesion between the two layers of the said laminate.

With the aim of improving conventional tyres by the use of an airtight layer predominantly based on a thermoplastic block elastomer comprising at least one central polyisobutylene block and adjacent blocks composed of at least one polymerized monomer, other than a styrene monomer, while simplifying the adhesion of such a layer to an adjacent crosslinked or non-crosslinked diene layer, the Applicant Company has found, surprisingly, the laminate of the invention.

A subject-matter of the invention is thus an airtight elastomeric laminate for tyres, the said laminate comprising at least two adjacent layers of elastomer:
a first layer, composed of a composition based on at least:
   a thermoplastic block elastomer comprising at least one central polyisobutylene block and adjacent blocks composed of at least one polymerized monomer, other than a styrene monomer, the content of the said thermoplastic block elastomer being within a range extending from more than 50 to 100 phr (parts by weight per 100 parts by weight of elastomer) and it being understood that the glass transition temperature of the said non-styrene polymer constituting the thermoplastic block of the thermoplastic block elastomer is greater than or equal to 60° C. and, in the case of a semicrystalline thermoplastic block, a melting point greater than 60° C.,
   and on a plasticizing system comprising from 1 to 40 phr of a plasticizing oil and from 1 to 40 phr of a hydrocarbon resin, the total content of plasticizer being within a range extending from 2 to 70 phr,
a second layer, composed of a composition based on at least one diene elastomer, the content of diene elastomer being within a range extending from more than 50 to 95 phr, and on at least one thermoplastic elastomer (TPE), the content of thermoplastic elastomer being within a range extending from 5 to less than 50 phr,
it being understood that at least 5 phr of the thermoplastic elastomers present in the second layer are compatible with at least 5 phr of the thermoplastic block elastomers present in the first layer.

This compatibility makes it possible to have a satisfactory adhesion between the two layers of the multilayer laminate of the invention. In comparison with the solutions of the prior art, the invention is of great simplicity, since it makes it possible to dispense with a layer, the only role of which would be the adhesion of the airtight layer to the diene layer, and thus not to make the tyre heavy and thus not to increase its rolling resistance.

Another major advantage of the invention is to make possible a saving in materials since, instead of using an additional elastomeric layer for the adhesion, the invention makes it possible for a predominantly diene layer (like the compositions of conventional tyres) to adhere to an airtight layer comprising a thermoplastic block elastomer comprising at least one central polyisobutylene block and adjacent blocks composed of at least one polymerized monomer, other than a styrene monomer. This saving is furthermore highly favourable to the protection of the environment.

Furthermore, the formulation of the layers of this laminate makes possible post-curing manufacture, that is to say application of the first layer of the laminate to the second layer after curing of the latter. Thus, for example, the first layer can be applied to the second layer, after curing a tyre provided with the said second layer as radially internal layer of the tyre; in particular, this application of the first layer is possible without any treatment being necessary on the second layer.

Preferably, the invention relates to a laminate as defined above, in which the number-average molecular weight of the thermoplastic block elastomer of the first layer is between 30 000 and 500 000 g/mol.

Preferably again, the invention relates to a laminate as defined above, in which the thermoplastic blocks of the thermoplastic block elastomer of the first layer are selected from the group consisting of polyolefins, polyurethanes, polyamides, polyesters, polyacetals, polyethers, polyphenylene sulphides, polyfluorinated compounds, polystyrenes, polycarbonates, polysulphones, polymethyl methacrylate, polyetherimide, thermoplastic copolymers and their mixtures.

Preferably again, the invention relates to a laminate as defined above, in which the content of thermoplastic block elastomer in the composition of the first layer is within a range extending from 70 to 100 phr, more preferably from 80 to 100 phr.

Preferably, the invention relates to a laminate as defined above, in which the thermoplastic elastomer is the only elastomer of the first layer.

Preferably, the invention relates to a laminate as defined above, in which the plasticizing system of the first layer comprises from 2 to 30 phr and preferably from 5 to 20 phr of a plasticizing oil.

Preferably again, the invention relates to a laminate as defined above, in which the plasticizing oil of the first layer is selected from the group consisting of polyolefinic oils, paraffinic oils, naphthenic oils, aromatic oils, mineral oils and the mixtures of these oils. Preferably, the plasticizing oil of the first layer is a polybutene oil and preferably a polyisobutylene oil.

Preferably, the invention relates to a laminate as defined above, in which the plasticizing system of the first layer comprises from 2 to 30 phr and preferably from 5 to 20 phr of hydrocarbon resin.

Preferably, the invention relates to a laminate as defined above, in which the hydrocarbon resin of the first layer is selected from the group consisting of cyclopentadiene or dicyclopentadiene homopolymer or copolymer resins, terpene homopolymer or copolymer resins, terpene/phenol homopolymer or copolymer resins, C₅ fraction homopolymer or copolymer resins, C₉ fraction homopolymer or copolymer resins, α-methylstyrene homopolymer or copolymer resins and the mixtures of these resins. Preferably, the hydrocarbon resin of the first layer is selected from the group consisting of copolymer resins of two different vinylaromatic monomers, (D)CPD/vinylaromatic, (D)CPD/terpene copolymer resins, (D)CPD/C₅ fraction copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and the mixtures of these resins. More preferably, the hydrocarbon resin of the first layer is selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins, styrene/α-methylstyrene copolymer resins and the mixtures of these resins. Very preferably, the hydrocarbon resin of the first layer is a styrene/α-methylstyrene copolymer resin.

Preferably, the invention relates to a laminate as defined above, in which the total content of plasticizer is within a range extending from 5 to 45 phr. Preferably, the total content of plasticizer is within a range extending from 10 to 35 phr.

Preferably again, the invention relates to a laminate as defined above, in which the first layer additionally comprises a platy filler.

Preferably, the invention relates to a laminate as defined above, in which the first layer does not comprise a crosslinking system.

Preferably again, the invention relates to a laminate as defined above, in which the number-average molecular weight of the thermoplastic elastomers of the second layer is between 30 000 and 500 000 g/mol.

Preferably, the invention relates to a laminate as defined above, in which the elastomer blocks of the thermoplastic elastomers (TPEs) of the second layer are chosen from elastomers having a glass transition temperature of less than 25° C.

Preferably again, the invention relates to a laminate as defined above, in which the elastomer blocks of the thermoplastic elastomers (TPEs) of the second layer are selected from the group consisting of ethylenic elastomers, diene elastomers and their mixtures. According to a preferred form, the elastomer blocks of the thermoplastic elastomers (TPEs) of the second layer are chosen from ethylenic elastomers. According to another preferred form, the elastomer blocks of the thermoplastic elastomers (TPEs) of the second layer are chosen from diene elastomers.

Preferably, the invention relates to a laminate as defined above, in which the thermoplastic blocks of the thermoplastic elastomers of the second layer are chosen from polymers having a glass transition temperature of greater than 60° C. and, in the case of a semicrystalline thermoplastic block, a melting point of greater than 60° C.

More preferably, the invention relates to a laminate as defined above, in which the thermoplastic blocks of the thermoplastic elastomers of the second layer are selected from the group consisting of polyolefins, polyurethanes, polyamides, polyesters, polyacetals, polyethers, polyphenylene sulphides, polyfluorinated compounds, polystyrenes, polycarbonates, polysulphones, polymethyl methacrylate, polyetherimide, thermoplastic copolymers and their mixtures.

Preferably, the invention relates to a laminate as defined above, in which the content of thermoplastic elastomer (TPE) in the composition of the second layer is within a range extending from 5 to 45 phr and more preferably from 10 to 40 phr.

Preferably, the invention relates to a laminate as defined above, in which the diene elastomer of the second layer is selected from the group consisting of essentially unsaturated diene elastomers and the mixtures of these elastomers. Preferably, the diene elastomer of the second layer is selected from the group consisting of the homopolymers obtained by polymerization of a conjugated diene monomer having from 4 to 12 carbon atoms, the copolymers obtained by copolymerization of one or more conjugated dienes with one another or with one or more vinylaromatic compounds having from 8 to 20 carbon atoms, and the mixtures of these. More preferably, the diene elastomer of the second layer is selected from the group consisting of polybutadienes, synthetic polyisoprenes, natural rubber, butadiene copolymers, isoprene copolymers and the mixtures of these elastomers.

Preferably, the invention relates to a laminate as defined above, in which the second layer comprises a reinforcing filler. Preferably, the reinforcing filler of the second layer is carbon black and/or silica. More preferably, the predominant reinforcing filler of the second layer is a carbon black.

The invention also relates to a tyre comprising a laminate as defined above.

Furthermore, the invention also relates to the use, in a pneumatic object, of a laminate as defined above.

The invention relates more particularly to the laminates as defined above, used in tyres intended to equip non-motor vehicles, such as bicycles, or motor vehicles of passenger vehicle type, SUVs (“Sport Utility Vehicles”), two-wheel vehicles (in particular motorcycles), aircraft, as well as industrial vehicles chosen from vans, “heavy-duty” vehicles—that is to say, underground trains, buses, road transport vehicles (lorries, tractors, trailers) or off-road vehicles, such as agricultural vehicles or vehicles for construction work—, or other transportation or handling vehicles.

The invention and its advantages will be easily understood in the light of the description and implementational examples which follow.

### DETAILED DESCRIPTION OF THE INVENTION

In the present description, unless expressly indicated otherwise, all the percentages (%) shown are percentages by weight.

Furthermore, the term “phr” means, within the meaning of the present patent application, parts by weight per hundred parts of elastomer, thermoplastics and dienes mixed together. Within the meaning of the present invention, thermoplastic elastomers (TPEs) are included among the elastomers.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

For the requirements of the present invention, it is specified that, in the present patent application, “thermoplastic layer” denotes an elastomeric layer comprising, by weight, a greater amount of thermoplastic elastomer(s) than of diene elastomer(s) and “diene layer” denotes an elastomeric layer comprising, by weight, a greater amount of diene elastomer(s) than of thermoplastic elastomer(s). The airtight layer of the laminate according to the invention predominantly comprising a thermoplastic block elastomer comprising at least one central polyisobutylene block and adjacent blocks composed of at least one polymerized monomer, other than a styrene monomer, is clearly a thermoplastic layer as defined above.

The laminate according to the invention exhibits an excellent adhesion between the two layers denoted, for the requirement of clarity of the invention, first and second layers (or respectively airtight thermoplastic layer and diene layer). Thus, according to the invention, the airtight thermoplastic layer as defined above can adhere with a diene layer as defined above, by virtue of the presence of a certain amount of TPE in this diene layer, compatible with a certain amount of TPE in the thermoplastic layer.

Within the meaning of the present invention, thermoplastic elastomers are compatible when they exhibit, as a mixture (of these two thermoplastic elastomers with one another), a single glass transition temperature or, in the case of semicrystalline thermoplastic blocks, a single melting point for the thermoplastic part of the mixture.

The details of the invention will be explained below by the description, in a first step, of the possible common constituents of the two layers of the laminate of the invention, then, in a second step, by the description of the specific components of each of the layers of the laminate of the invention and, finally, by the description of the adhesion between the two layers of the laminate according to the invention.

The airtight laminate according to the invention has the essential characteristic of being provided with at least two elastomeric layers referred to as “airtight thermoplastic layer” and “diene layer” with different formulations, the said layers of the said laminate comprising at least one thermoplastic elastomer (TPE) as defined below, including the thermoplastic block elastomer comprising at least one central polyisobutylene block and adjacent blocks composed of at least one polymerized monomer, other than a styrene monomer, in the airtight layer. In addition to the thermoplastic block elastomer comprising at least one central polyisobutylene block and adjacent blocks composed of at least one polymerized monomer, other than a styrene monomer, the airtight layer comprises a plasticizing system, the composition of which will be described in detail below. In addition to the thermoplastic elastomer (TPE), the diene layer also comprises a diene elastomer; its composition will be described in detail in that which follows.

I—Composition of the Airtight Layer of the Laminate of the Invention

The first layer, which is leakproof to air or more generally any inflating gas, comprises more than 50 phr of a thermoplastic block elastomer (TPE) comprising at least one central polyisobutylene block and adjacent blocks composed of at least one polymerized monomer, other than a styrene monomer, (abbreviated to isobutylene and non-styrene thermoplastic elastomer or “TPE-IB-NS”) and a plasticizing system.

I—1. Isobutylene and Non-Styrene Thermoplastic Elastomer or “TPE-IB-NS”

Thermoplastic elastomers (abbreviated to “TPEs”) have a structure intermediate between elastomers and thermoplastic polymers. These are block copolymers composed of rigid thermoplastic blocks connected via flexible elastomer blocks.

The TPE-IB-NS thermoplastic elastomer used for the implementation of the invention is a block copolymer, the chemical nature of the thermoplastic and elastomer blocks of which can vary.

I—1.1. Structure of the TPE-IB-NS

The number-average molecular weight (denoted Mn) of the TPE-IB-NS is preferably between 30 000 and 500 000 g/mol, more preferably between 40 000 and 400 000 g/mol. Below the minima indicated, there is a risk of the cohesion between the elastomer chains of the TPE-IB-NS being affected, in particular due to its possible dilution (in the presence of an extending oil); furthermore, there is a risk of an increase in the working temperature affecting the mechanical properties, in particular the properties at break, with the consequence of a reduced “hot” performance. Furthermore, an excessively high Mn weight can be damaging to the implementation. Thus, it has been found that a value within a range from 50 000 to 300 000 g/mol is particularly well suited, in particular to use of the TPE in a tyre multilayer laminate composition.

The number-average molecular weight (Mn) of the TPE-IB-NS elastomer is determined in a known way by steric exclusion chromatography (SEC). For example, in the case of styrene thermoplastic elastomers, the sample is dissolved beforehand in tetrahydrofuran at a concentration of approximately 1 g/l and then the solution is filtered through a filter with a porosity of 0.45 μam before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel tradenames (HMW7, HMW6E and two HT6E), is used. The injected volume of the solution of the polymer sample is 100 μl. The detector is a Waters 2410 differential refractometer, and its associated software, for making use of the chromatographic data, is the Waters Millennium system. The calculated average molar masses are relative to a calibration curve produced with polystyrene standards. The conditions can be adjusted by a person skilled in the art.

The value of the polydispersity index PI (reminder: PI=Mw/Mn, with Mw the weight-average molecular weight and Mn the number-average molecular weight) of the TPE is preferably less than 3, more preferably less than 2 and more preferably still less than 1.5.

In the present patent application, when reference is made to the glass transition temperature of the TPE-IB-NS, it concerns the Tg relative to the elastomer block. The TPE-IB-NS preferably exhibits a glass transition temperature (“Tg”) which is preferably less than or equal to 25° C., more preferably less than or equal to 10° C. A Tg value greater than these minima can reduce the performance of the multilayer laminate when used at very low temperature; for such a use, the Tg of the TPE-IB-NS is more preferably still less than or equal to −10° C. Preferably again, the Tg of the TPE-IB-NS is greater than −100° C.

As in a way known for TPEs, TPE-IB-NSs exhibit two glass transition temperature peaks (Tg, measured according to ASTM D3418), the lowest temperature being relative to the elastomer part of the TPE-IB-NS and the highest temperature being relative to the thermoplastic part of the TPE-IB-NS. Thus, the flexible blocks of the TPE-IB-NSs are defined by a Tg which is less than ambient temperature (25° C.), while the rigid blocks have a Tg which is greater than 60° C.

In order to be both elastomeric and thermoplastic in nature, the TPE-IB-NS has to be provided with blocks which are sufficiently incompatible (that is to say, different as a result of their respective weights, their respective polarities or their respective Tg values) to retain their own properties of elastomer block or thermoplastic block.

The TPE-IB-NSs are preferably copolymers with a small number of blocks (less than 5, typically 3), in which case these blocks preferably have high weights of greater than 15 000 g/mol. These TPE-IB-NSs can, for example, be triblock copolymers with two rigid segments connected by a flexible segment. The rigid and flexible segments can be positioned linearly, or in a star or branched configuration. Typically, each of these segments or blocks often comprises a minimum of more than 5, generally of more than 10, base units (for example, amide units and isobutylene units for an amide/isobutylene/amide block copolymer). It will be said, by convention, that the polyisobutylene block is central in the TPE-IB-NS.

According to a first alternative form, the TPE-IB-NS is provided in a linear form. For example, the TPE-IB-NS is a triblock copolymer: thermoplastic block/elastomer block/thermoplastic block, that is to say a central elastomer block and two terminal thermoplastic blocks, at each of the two ends of the elastomer block.

According to another alternative form of the invention, the TPE-IB-NS of use for the requirements of the invention is provided in a star-branched form comprising at least three branches. For example, the TPE-IB-NS can then be composed of a star-branched elastomer block comprising at least three branches and of a thermoplastic block located at the end of each of the branches of the elastomer block. The number of branches of the central elastomer can vary, for example, from 3 to 12 and preferably from 3 to 6.

According to another alternative form of the invention, the TPE-IB-NS is provided in a branched or dendrimer form. The TPE-IB-NS can then be composed of a branched or dendrimer elastomer block and of a thermoplastic block located at the end of the branches of the dendrimer elastomer block.

I—1.2. Nature of the Isobutylene Elastomer Blocks

The elastomer blocks of the TPE-IB-NS for the requirements of the invention are polyisobutylene blocks, that is to say that this elastomer block of the TPE-IB-NS is preferably predominantly composed of isobutylene units. Predominantly is understood to mean a content by weight of isobutylene monomer which is the highest, with respect to the total weight of the elastomer block, and preferably a content by weight of more than 50%, more preferably of more than 75% and more preferably still of more than 85%.

Conjugated C₄-C₁₄ dienes can be copolymerized with the isobutylene monomers. They are, in this case, random copolymers. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is chosen from butadiene or isoprene or a mixture comprising butadiene and isoprene.

According to an alternative form, the isobutylene monomers polymerized in order to form the elastomer part of the TPE-IB-NS can be randomly copolymerized with at least one other monomer, so as to form an elastomer block. According to this alternative form, the molar fraction of polymerized monomer, other than an isobutylene monomer, with respect to the total number of units of the elastomer block, has to be such that this block retains its elastomer properties. Advantageously, the molar fraction of this other comonomer can range from 0% to 50%, more preferably from 0% to 45% and more preferably still from 0% to 40%.

According to a preferred embodiment of the invention, the elastomer blocks of the TPE-IB-NS exhibit, in total, a number-average molecular weight (Mn) ranging from 25 000 g/mol to 350 000 g/mol, preferably from 35 000 g/mol to 250 000 g/mol, so as to confer, on the TPE-IB-NS, good elastomeric properties and a mechanical strength which is sufficient and compatible with the use as tyre multilayer laminate.

The elastomer block can also be a block comprising, in addition to the isobutylene monomers, several types of ethylenic, diene or styrene monomers as defined above.

The elastomer block can also be composed of several elastomer blocks as defined above.

I—1.3. Nature of the Non-Styrene Thermoplastic Blocks

The TPE-IB-NSs comprise, in addition to the central isobutylene elastomer block, at least two adjacent thermoplastic blocks composed of at least one polymerized monomer, other than a styrene monomer (referred to as non-styrene thermoplastic blocks). Polymerized monomer, other than a styrene monomer, should be understood as meaning, in the present description, any monomer, other than a styrene monomer, polymerized according to techniques known to a person skilled in the art and which can result in the preparation of a thermoplastic block elastomer as used for the implementation of the invention. Styrene monomer should be understood as meaning, in the present description, any monomer comprising styrene, unsubstituted and substituted; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or also para-hydroxystyrene.

Use will be made, for the definition of the thermoplastic blocks, of the characteristic of glass transition temperature (Tg) of the rigid thermoplastic block. This characteristic is well known to a person skilled in the art. It makes it possible in particular to choose the industrial processing (transformation) temperature. In the case of an amorphous polymer (or polymer block), the processing temperature is chosen to be substantially greater than the Tg of the thermoplastic block. In the specific case of a semicrystalline polymer (or polymer block), a melting point may be observed which is then greater than the glass transition temperature. In this case, it is instead the melting point (M.p.) which makes it possible to choose the processing temperature for the polymer (or polymer block) under consideration. Thus, subsequently, when reference will be made to “Tg (or M.p., if appropriate)”, this will have to be regarded as the temperature used to choose the processing temperature.

For the requirements of the invention, the TPE-IB-NS elastomers comprise one or more thermoplastic block(s) preferably having a Tg (or M.p., if appropriate) of greater than or equal to 60° C. and formed from polymerized monomers. Preferably, this thermoplastic block has a Tg (or M.p., if appropriate) within a range varying from 60° C. to 250° C. Preferably, the Tg (or M.p., if appropriate) of this thermoplastic block is preferably from 70° C. to 200° C., more preferably from 80° C. to 180° C.

The proportion of the thermoplastic blocks, with respect to the TPE-IB-NS as defined for the implementation of the invention, is determined, on the one hand, by the thermoplasticity properties which the said copolymer has to exhibit. The thermoplastic blocks having a Tg (or M.p., if appropriate) of greater than or equal to 60° C. are preferably present in proportions sufficient to retain the thermoplastic nature of the elastomer of use in the invention. The minimum content of thermoplastic blocks having a Tg (or M.p., if appropriate) of greater than or equal to 60° C. in the TPE-IB-NS can vary as a function of the conditions of use of the copolymer. On the other hand, the ability of the TPE-IB-NS to deform during the preparation of the tyre can also contribute to determining the proportion of the thermoplastic blocks having a Tg (or M.p., if appropriate) of greater than or equal to 60° C.

The thermoplastic blocks having a Tg (or M.p., if appropriate) of greater than or equal to 60° C. can be formed from polymerized monomers of various natures; in particular, they can constitute the following blocks or their mixtures:
polyolefins (polyethylene, polypropylene);
polyurethanes;
polyamides;
polyesters;
polyacetals;
polyethers (polyethylene oxide, polyphenylene ether);
polyphenylene sulphides;
polyfluorinated compounds (FEP, PFA, ETFE);
polycarbonates;
polysulphones;
polymethyl methacrylate;
polyetherimide;
thermoplastic copolymers, such as the acrylonitrile/butadiene/styrene (ABS) copolymer.

The thermoplastic blocks having a Tg (or M.p., if appropriate) of greater than or equal to 60° C. can also be obtained from monomers chosen from the following compounds and their mixtures:
acenaphthylene: a person skilled in the art may refer, for example, to the paper by Z. Fodor and J. P. Kennedy, Polymer Bulletin, 1992, 29(6), 697-705;
indene and its derivatives, such as, for example, 2-methylindene, 3-methylindene, 4-methylindene, dimethylindene, 2-phenylindene, 3-phenylindene and 4-phenylindene; a person skilled in the art may, for example, refer to the patent document U.S. Pat. No. 4,946,899, by the inventors Kennedy, Puskas, Kaszas and Hager, and to the documents by J. E. Puskas, G. Kaszas, J. P. Kennedy and W. G. Hager, Journal of Polymer Science Part A: Polymer Chemistry (1992), 30, 41, and J. P. Kennedy, N. Meguriya and B. Keszler, Macromolecules (1991), 24(25), 6572-6577;
isoprene, then resulting in the formation of a certain number of trans-1,4-polyisoprene units and of units cyclized according to an intramolecular process; a person skilled in the art may, for example, refer to the documents by G. Kaszas, J. E. Puskas and J. P. Kennedy, Applied Polymer Science (1990), 39(1), 119-144, and J. E. Puskas, G. Kaszas and J. P. Kennedy, Macromolecular Science, Chemistry A28 (1991), 65-80.

According to an alternative form of the invention, the polymerized monomer as defined above can be copolymerized with at least one other monomer, so as to form a thermoplastic block having a Tg (or M.p., if appropriate) as defined above.

By way of illustration, this other monomer capable of copolymerizing with the polymerized monomer can be chosen from diene monomers, more particularly conjugated diene monomers having from 4 to 14 carbon atoms, and monomers of vinylaromatic type having from 8 to 20 carbon atoms, such as defined in the part relating to the elastomer block. When the comonomer is of styrene type, it has to represent less than 5% by weight of the thermoplastic block in order for the TPE-IB-NS to be regarded as of non-styrene nature.

According to the invention, the thermoplastic blocks of the TPE-IB-NS exhibit, in total, a number-average molecular weight (“Mn”) ranging from 5000 g/mol to 150 000 g/mol, so as to confer, on the TPE-IB-NS, good elastomeric properties and a mechanical strength which is sufficient and compatible with the use as tyre multilayer laminate.

The thermoplastic block can also be composed of several thermoplastic blocks as defined above.

I—1.4. Preparation of the TPE-IB-NSs

The TPE-IB-NS thermoplastic elastomers can be prepared by known synthetic processes. A person skilled in the art will know how to choose the appropriate polymerization conditions and to adjust the various parameters of the polymerization processes in order to result in the specific structural characteristics of the thermoplastic block elastomer of use for the implementation of the invention.

Several synthetic strategies can be employed for the purpose of preparing the copolymers of use in the implementation of the invention.

A first consists of a first stage of synthesis of the “polyisobutylene” block by living cationic polymerization of the monomers to be polymerized by means of a monofunctional, bifunctional or polyfunctional initiator known to a person skilled in the art, followed by the second stage of synthesis of the thermoplastic block or blocks having a Tg of greater than or equal to 60° C. by addition, of the monomer to be polymerized, to the living polyisobutylene obtained in the first stage. Thus, these two stages are consecutive, which is reflected by the sequenced addition:

of the monomers to be polymerized for the preparation of the “polyisobutylene” block;

of the monomers to be polymerized for the preparation of the thermoplastic block or blocks having a Tg of greater than or equal to 60° C.

In each stage, the monomer or monomers to be polymerized may or may not be added in the form of a solution in a solvent as is described below, in or not in the presence of a Lewis acid or base as are described below.

Each of these stages can be carried out in one and the same reactor or in two different polymerization reactors. Preferably, these two stages are carried out in one and only one reactor (one-pot synthesis).

The living cationic polymerization is carried out conventionally by means of a bifunctional or polyfunctional initiator and optionally of a Lewis acid acting as coinitiator in order to form a carbocation in situ. Usually, electron-donating compounds are added in order to confer a living nature on the polymerization.

By way of illustration, the bifunctional or polyfunctional initiators which can be used for the preparation of the copolymers of use in the invention can be chosen from 1,4-di(2-methoxy-2-propyl)benzene (or “dicumyl methyl ether”), 1,3,5-tri(2-methoxy-2-propyl)benzene (or “tricumyl methyl ether”), 1,4-di(2-chloro-2-propyl)benzene (or “dicumyl chloride”), 1,3,5-tri(2-chloro-2-propyl)benzene (or “tricumyl chloride”), 1,4-di(2-hydroxy-2-propyl)benzene, 1,3,5-tri(2-hydroxy-2-propyl)benzene, 1,4-di(2-acetoxy-2-propyl)benzene, 1,3,5-tri(2-acetoxy-2-propyl)benzene, 2,6-dichloro-2,4,4,6-tetramethylheptane or 2,6-dihydroxy-2,4,4,6-heptane. Preferably, dicumyl ethers, tricumyl ethers, dicumyl halides or tricumyl halides are used.

The Lewis acids can be chosen from metal halides of general formula MXₐ, where M is an element chosen from Ti, Zr, Al, Sn, P or B, X is a halogen, such as Cl, Br, F or I, and n corresponds to the degree of oxidation of the element M. Mention will be made, for example, of TiCl₄, AlCl₃, BCl₃, BF₃, SnCl₄, PCl₃ or PCl₅. Among these compounds, TiCl₄, AlCl₃ and BCl₃ are preferably used and more preferably still TiCl₄.

The electron-donating compounds can be chosen from known Lewis bases, such as pyridines, amines, amides, esters, sulphoxides and others. Preference is given, among these, to DMSO (dimethyl sulphoxide) and DMAc (dimethylacetamide).

The living cationic polymerization is carried out in an inert nonpolar solvent or in a mixture of inert nonpolar and polar solvents.

The nonpolar solvents which can be used for the synthesis of the copolymers of use in the invention are, for example, aliphatic, cycloaliphatic or aromatic hydrocarbon solvents, such as hexane, heptane, cyclohexane, methylcyclohexane, benzene or toluene.

The polar solvents which can be used for the synthesis of the copolymers of use in the invention are, for example, halogenated solvents, such as alkyl halides, for example methyl chloride (or chloroform), ethyl chloride, butyl chloride, methylene chloride (or dichloromethane) or chlorobenzenes (mono-, di- or trichloro).

A person skilled in the art will know how to choose the composition of the mixtures of monomers to be used for the purpose of preparing the thermoplastic block elastomeric copolymers of use in the invention and also the appropriate temperature conditions for the purpose of achieving the characteristics of molar masses of these copolymers.

As illustrative but nonlimiting example and in order to implement this first synthetic strategy, a person skilled in the art may refer to the following documents for the synthesis of a thermoplastic block elastomer based on isobutylene and on:
acenaphthylene: the paper by Z. Fodor and J. P. Kennedy, Polymer Bulletin, 1992, 29(6), 697-705;
indene: the patent document U.S. Pat. No. 4,946,899 by the inventors Kennedy, Puskas, Kaszas and Hager and the documents J. E. Puskas, G. Kaszas, J. P. Kennedy and W. G. Hager, Journal of Polymer Science Part A: Polymer Chemistry (1992), 30, 41, and J.P. Kennedy, N. Meguriya and B. Keszler, Macromolecules (1991), 24(25), 6572-6577;
isoprene: the documents G. Kaszas, J. E. Puskas and J. P. Kennedy, Applied Polymer Science (1990), 39(1), 119-144, and J. E. Puskas, G. Kaszas and J. P. Kennedy, Macromolecular Science, Chemistry A28 (1991), 65-80.

A second synthetic strategy consists in separately preparing:
a “polyisobutylene” block which is telechelic or functional at one or more of its chain ends by living cationic polymerization by means of a monofunctional, bifunctional or polyfunctional initiator, optionally followed by a functionalization reaction on one or more chain ends,
the living thermoplastic block or blocks, for example by anionic polymerization, having a Tg of greater than or equal to 60° C.,
and in then reacting both of them in order to obtain a thermoplastic block elastomer of use in the implementation of the invention. The nature of the reactive functional groups at at least one of the chain ends of the “polyisobutylene” block and the proportion of living chains of the polymer constituting the thermoplastic block having a Tg of greater than or equal to 60° C., with respect to the amount of these reactive functional groups, will be chosen by a person skilled in the art in order to obtain a thermoplastic block elastomer of use in the implementation of the invention.

A third synthetic strategy consists in carrying out, in this order:
the synthesis of a “polyisobutylene” block which is telechelic or functional at one or more of its chain ends by living cationic polymerization by means of a monofunctional, bifunctional or polyfunctional initiator;
the modification at the chain end of this “polyisobutylene”, so as to introduce a monomer unit which may be lithiated;
optionally, the supplementary addition of a monomer unit which may be lithiated and result in an entity capable of initiating an anionic polymerization, such as, for example, 1,1-diphenylethylene;
finally, the addition of the polymerizable and of optional comonomers monomer by the anionic route.

As example for the implementation of such a synthetic strategy, a person skilled in the art may refer to the communication by Kennedy and Price, ACS Symposium, 1992, 496, 258-277, or to the paper by Faust et al.: Facile synthesis of diphenylethylene end-functional polyisobutylene and its applications for the synthesis of block copolymers containing poly(methacrylate)s, by Dingsong Feng, Tomoya Higashihara and Rudolf Faust, Polymer, 2007, 49(2), 386-393.

The halogenation of the copolymer of use in the invention is carried out according to any method known to a person skilled in the art, in particular those used for the halogenation of butyl rubber, and can be carried out, for example, by means of bromine or chlorine, preferably bromine, on the units resulting from conjugated dienes of the polymeric chain of the “polyisobutylene” block and/or of the thermoplastic block or blocks.

In some alternative forms of the invention according to which the thermoplastic elastomer is star-branched or else branched, the processes described, for example, in the papers by Puskas, J. Polym. Sci. Part A: Polymer Chemistry, Vol. 36, pp 85-82 (1998), and Puskas, J. Polym. Sci. Part A: Polymer Chemistry, Vol. 43, pp 1811-1826 (2005), can be analogously employed in order to obtain living star-branched, branched or dendrimer “polyisobutylene” blocks.

A person skilled in the art will then know how to choose the composition of the mixtures of monomers to be used for the purpose of preparing the copolymers of use in the invention and also the appropriate temperature conditions for the purpose of achieving the characteristics of molar masses of these copolymers.

Preferably, the preparation of the copolymers of use for the requirements of the invention will be carried out by living cationic polymerization by means of a bifunctional or polyfunctional initiator and by sequenced additions of the monomers to be polymerized for the synthesis of the “polyisobutene” block and of the monomers to be polymerized for the synthesis of the thermoplastic block or blocks having a Tg of greater than or equal to 60° C.

I—1.5. Amount of TPE-IB-NS

The content of TPE-IB-NS in the thermoplastic layer (that is to say, the total content if there are several TPE-IB-NSs) is within a range extending from more than 50 to 100 phr. Preferably, the content of thermoplastic block elastomer comprising at least one central polyisobutylene block and adjacent blocks composed of at least one polymerized monomer, other than a styrene monomer (TPE-IB-NS), in the first airtight composition is within a range extending from 70 to 100 phr, in particular within a range extending from 80 to 100 phr.

However, according to a particularly preferred embodiment, the thermoplastic block elastomer comprising at least one central polyisobutylene block and adjacent blocks composed of at least one polymerized monomer, other than a styrene monomer, is the only thermoplastic elastomer and more generally the only elastomer present in the gastight layer; consequently, in such a case, its content is equal to 100 phr.

The gastight layer described above might optionally comprise other elastomers than the thermoplastic block elastomer comprising at least one central polyisobutylene block and adjacent blocks composed of at least one polymerized monomer, other than a styrene monomer, in a minor amount (less than 50 phr).

Such additional elastomers might, for example, be diene elastomers as defined in that which follows for the diene layer of the laminate of the invention. Mention may in particular be made, as diene elastomers which can be used in addition to the thermoplastic block elastomer described above, of polybutadienes (BRs), synthetic polyisoprenes (IRs), natural rubber (NR), butadiene copolymers, isoprene copolymers and the mixtures of these elastomers. Such copolymers are more preferably selected from the group consisting of butadiene/styrene copolymers (SBRs), isoprene/butadiene copolymers (BIRs), isoprene/styrene copolymers (SIRs), isoprene/isobutylene copolymers (IIRs), isoprene/butadiene/styrene copolymers (SBIRs) and the mixtures of such copolymers.

Such additional elastomers might also, for example, be other thermoplastic elastomers. Mention may in particular be made, as TPE elastomer which can be used in addition to the thermoplastic block elastomer described above, of a TPS elastomer selected from the group consisting of styrene/butadiene/styrene block copolymers (SBSs), styrene/isoprene/styrene block copolymers (SISs), styrene/butylene/styrene, styrene/butadiene/isoprene/styrene block copolymers (SBISs), styrene/ethylene/butylene/styrene block copolymers (SEBSs), styrene/ethylene/propylene/styrene block copolymers (SEPSs), styrene/ethylene/ethylene/propylene/styrene block copolymers (SEEPSs), styrene/ethylene/ethylene/styrene block copolymers (SEESs) and the mixtures of these copolymers. More preferably, the said optional additional TPS elastomer is selected from the group consisting of SEBS block copolymers, SEPS block copolymers and the mixtures of these copolymers.

In the case where other elastomers are present, other than the thermoplastic block elastomer comprising at least one central polyisobutylene block and adjacent blocks composed of at least one polymerized monomer, other than a styrene monomer, their total content is within a range extending from 0 to less than 50 phr, preferably from 0 to less than 30 phr and more preferably from 0 to less than 20 phr.

The thermoplastic block elastomer comprising at least one central polyisobutylene block and adjacent blocks composed of at least one polymerized monomer, other than a styrene monomer described above, is thus sufficient in itself alone for there to be fulfilled, in the first elastomer layer, the role of gastightness with regard to the pneumatic objects in which they are used.

I—2. Plasticizing System

The plasticizing system of the airtight layer of the laminate of the invention is composed of a plasticizing oil and of a hydrocarbon resin.

The function of the plasticizing system is to facilitate the processing, in particular the incorporation in a pneumatic object, by a lowering of the viscosity and an increase in the tackifying power of the gastight layer and thus of the laminate of the invention. This plasticizing system comprises a plasticizing oil and a hydrocarbon resin, the total content of plasticizer being within a range extending from 2 to 70 phr, preferably from 5 to 45 phr and more preferably from 10 to 35 phr.

For the requirements of the present invention, the plasticizers, that is to say the oil and the resin, are preferably compatible with the thermoplastic block elastomer comprising at least one central polyisobutylene block and adjacent blocks composed of at least one polymerized monomer, other than a styrene monomer. Plasticizer compatible with the thermoplastic block elastomer comprising at least one central polyisobutylene block and adjacent blocks composed of at least one polymerized monomer, other than a styrene monomer, is understood to mean a plasticizer (oil or resin, according to the plasticizer under consideration) which exhibits, as a mixture with the thermoplastic block elastomer comprising at least one central polyisobutylene block and adjacent blocks composed of at least one polymerized monomer, other than a styrene monomer, a single glass transition temperature (Tg) for the elastomeric part of the mixture. The said compatibility of the plasticizers with the thermoplastic block elastomer comprising at least one central polyisobutylene block and adjacent blocks composed of at least one polymerized monomer, other than a styrene monomer, makes possible an optimum effect of the plasticizers.

The plasticizing oil (or extending oil) is used at a content ranging from 1 to 40 phr, phr meaning parts by weight per hundred parts of total elastomer (i.e., above thermoplastic block elastomer comprising at least one central polyisobutylene block and adjacent blocks composed of at least one polymerized monomer, other than a styrene monomer, plus additional elastomers, if appropriate) present in the first airtight layer.

Below the minimum indicated, there is a risk of the gastight layer and thus of the multilayer laminate exhibiting too great a viscosity to be deposited on the diene layer after curing of the latter and to penetrate into the crevices of the diene layer, whereas, above the maximum recommended, there is a danger of an excessively high cold creep capable of resulting in undesirable movements of materials by centrifuging during the rotating of the tyre.

For these reasons, it is preferable for the extending oil to be used at a content ranging from 2 to 30 phr and more preferably from 5 to 20 phr.

Use may be made of any extending oil, preferably having a weakly polar nature, capable of extending or plasticizing elastomers, in particular thermoplastic elastomers.

At ambient temperature (23° C.), these oils, which are more or less viscous, are liquids (that is to say, as a reminder, substances which have the ability to eventually assume the shape of their container), in contrast in particular to resins, which are by nature solids.

Preferably, the extending oil is selected from the group consisting of polyolefinic oils (that is to say, resulting from the polymerization of monoolefinic or diolefinic olefins), paraffinic oils, naphthenic oils (of low or high viscosity), aromatic oils, mineral oils and the mixtures of these oils.

Use is preferably made of polybutene oils, particularly polyisobutylene (abbreviated to “PIB”) oils, which have demonstrated the best compromise in properties in comparison with the other oils tested, in particular with oils of the paraffinic type.

By way of examples, polyisobutylene oils are sold in particular by Univar under the Dynapak Poly name (e.g., Dynapak Poly 190), by BASF under the Glissopal (e.g., Glissopal 1000) or Oppanol (e.g., Oppanol B12) names and by Ineos Oligomer under the name Indopol H1200. Paraffinic oils are sold, for example, by Exxon under the name Telura 618 or by Repsol under the name Extensol 51.

The number-average molecular weight (Mn) of the extending oil is preferably between 200 and 25 000 g/mol, more preferably still between 300 and 10 000 g/mol. For excessively low Mn weights, there exists a risk of migration of the oil outside the composition, whereas excessively high weights can result in excessive stiffening of this composition. An Mn weight of between 350 and 4000 g/mol, in particular between 400 and 3000 g/mol, has proved to constitute an excellent compromise for the targeted applications, in particular for use in a tyre.

The number-average molecular weight (Mn) of the extending oil is determined by SEC, the sample being dissolved beforehand in tetrahydrofuran at a concentration of approximately 1 g/l; the solution is then filtered through a filter with a porosity of 0.45 μm before injection. The apparatus is the Waters Alliance chromatographic line. The elution solvent is tetrahydrofuran, the flow rate is 1 ml/min, the temperature of the system is 35° C. and the analytical time is 30 min. A set of two Waters columns with the Styragel HT6E name is used. The injected volume of the solution of the polymer sample is 100 μl. The detector is a Waters 2410 differential refractometer and its associated software, for making use of the chromatographic data, is the Waters Millennium system. The calculated average molar masses are relative to a calibration curve produced with polystyrene standards.

A person skilled in the art will know, in the light of the description and implementational examples which follow, how to adjust the amount of extending oil as a function of the specific working conditions of the gastight thermoplastic layer, in particular of the pneumatic object in which it is intended to be used.

Also, the plasticizing system of the first layer of the laminate of the invention comprises a hydrocarbon resin.

The designation “resin” is reserved in the present patent application, by definition known to a person skilled in the art, for a compound which is solid at ambient temperature (23° C.), in contrast to a liquid plasticizing compound, such as an oil.

Hydrocarbon resins are polymers well known to a person skilled in the art, essentially based on carbon and hydrogen, which can be used in particular as plasticizing agents in polymer matrices. They have been described, for example, in the work entitled “Hydrocarbon Resins” by R. Mildenberg, M. Zander and G. Collin (New York, VCH, 1997, ISBN 3-527-28617-9), Chapter 5 of which is devoted to their applications, in particular in the tyre rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic and are or are not based on petroleum (if such is the case, they are also known under the name of petroleum resins). They are by definition miscible (i.e., compatible) at the contents used with the polymer compositions for which they are intended, so as to act as true diluents. Their Tg is preferably greater than 0° C., in particular greater than 20° C. (generally between 30° C. and 120° C.).

In a known way, these hydrocarbon resins can also be described as thermoplastic resins in the sense that they soften when heated and can thus be moulded. They can also be defined by a softening point, the temperature at which the product, for example in the powder form, sticks together. The softening point of a hydrocarbon resin is generally greater by approximately 50 to 60° C. than its Tg value.

In the plasticizing system, the resin is used at a content by weight ranging from 1 to 40 phr. Below 1 phr, the effect of the resin is not very noteworthy, whereas, above 40 phr, there is a danger of a simultaneous increase in the hysteresis. For these reasons, the content of resin is preferably from 2 to 30 phr and very preferably from 5 to 20 phr.

According to a preferred embodiment of the invention, the hydrocarbon resin exhibits at least any one, more preferably all, of the following characteristics:
a Tg of greater than 10° C. and more preferably of greater than 30° C.;
a softening point of greater than 50° C., preferably of greater than 80° C. (in particular of between 80° C. and 160° C.);
a number-average molar mass (Mn) of between 200 and 3000 g/mol;
a polydispersity index (PI) of less than or equal to 4 (reminder: PI=Mw/Mn with Mw the weight-average molar mass).

More preferably, this hydrocarbon resin exhibits at least any one, more preferably all, of the following characteristics:
a Tg of between 30° C. and 120° C. (in particular between 35° C. and 105° C.);
a softening point of greater than 90° C., in particular of between 110° C. and 150° C.;
an average mass Mn of between 400 and 1500 g/mol;
a polydispersity index PI of less than 3 and in particular of less than 2.

The softening point is measured according to Standard ISO 4625 (ring and ball method). The Tg is measured according to Standard ASTM D3418 (1999). The macrostructure (Mw, Mn and PI) of the hydrocarbon resin is determined by steric exclusion chromatography (SEC): solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

Mention may be made, as examples of such hydrocarbon resins, of those selected from the group consisting of cyclopentadiene (abbreviated to CPD) or dicyclopentadiene (abbreviated to DCPD) homopolymer or copolymer resins, terpene homopolymer or copolymer resins, terpene/phenol homopolymer or copolymer resins, C₅ fraction homopolymer or copolymer resins, C₉ fraction homopolymer or copolymer resins, α-methylstyrene homopolymer or copolymer resins and the mixtures of these resins. Mention may more particularly be made, among the above copolymer resins, of those selected from the group consisting of copolymer resins of two different vinylaromatic monomers, (D)CPD/vinylaromatic, (D)CPD/terpene copolymer resins, (D)CPD/C₅ fraction copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and the mixtures of these resins.

The term “terpene” combines here, in a known way, α-pinene, β-pinene and limonene monomers; use is preferably made of a limonene monomer, which compound exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomer are, for example: styrene, α-methylstyrene, ortho-methylstyrene, meta-methylstyrene, para-methylstyrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer resulting from a C₉ fraction (or more generally from a C₈ to C₁₀ fraction).

More particularly, mention may be made of the resins selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins, styrene/α-methylstyrene copolymer resins and the mixtures of these resins. Very preferably, the resin is a styrene/α-methylstyrene copolymer resin.

All the above resins are well known to a person skilled in the art and are commercially available, for example sold by DRT under the name Dercolyte as regards polylimonene resins, by Neville Chemical Company under the name Super Nevtac, by Kolon under the name Hikorez or by Exxon Mobil under the name Escorez as regards C₅ fraction/styrene resins or C₅ fraction/C₉ fraction resins, by Struktol under the name 40 MS or 40 NS (mixtures of aromatic and/or aliphatic resins), by Eastman under the name Eastotac, such as Eastotac H-142W, as regards hydrogenated aliphatic hydrocarbon resins, or also by Arizona under the name Sylvares SA 140 for styrene/α-methylstyrene resins.

I-3. Platy Fillers

The elastomers and plasticizers described above are sufficient in themselves alone for the multilayer laminate according to the invention to be usable; nevertheless, a platy filler can be used in the composition of the airtight layer of the laminate of the invention.

The preferred use of platy filler advantageously makes it possible to lower the coefficient of permeability (and thus to increase the airtightness) of the elastomer composition, without excessively increasing its modulus, which makes it possible to retain the ease of incorporation of the airtight layer in the pneumatic object.

“Platy” fillers are well known to a person skilled in the art. They have been used in particular in tyres in order to reduce the permeability of conventional gastight layers based on butyl rubber. In these butyl-based layers, they are generally used at relatively low contents, generally not exceeding 10 to 15 phr (see, for example, the patent documents US 2004/0194863 and WO 2006/047509).

They are generally provided in the form of stacked plates, platelets, sheets or lamellae, with a more or less marked anisometry. Their aspect ratio (A=L/T) is generally greater than 3, more often greater than 5 or than 10, L representing the length (or greatest dimension) and T representing the mean thickness of these platy fillers, these means being calculated on a number basis. Aspect ratios reaching several tens, indeed even several hundreds, are frequent. Their mean length is preferably greater than 1 μm (that is to say that “micrometric” platy fillers are then involved), typically of between a few μm (for example 5 μm) and a few hundred μm (for example 500 μm, indeed even 800 μm).

Preferably, the platy fillers used in accordance with the invention are selected from the group consisting of graphites, phyllosilicates and the mixtures of such fillers. Mention will in particular be made, among phyllosilicates, of clays, talcs, micas or kaolins, it being possible for these phyllosilicates to be or not to be modified, for example by a surface treatment; mention may in particular be made, as examples of such modified phyllosilicates, of micas covered with titanium oxide or clays modified by surfactants (“organo clays”).

Use is preferably made of platy fillers having a low surface energy, that is to say which are relatively nonpolar, such as those selected from the group consisting of graphites, talcs, micas and the mixtures of such fillers, it being possible for the latter to be or not to be modified, more preferably still from the group consisting of graphites, talcs and the mixtures of such fillers. Mention may in particular be made, among graphites, of natural graphites, expanded graphites or synthetic graphites.

Mention may be made, as examples of micas, of the micas sold by CMMP (Mica-MU®, Mica-Soft® and Briomica®, for example), vermiculites (in particular the vermiculite Shawatec® sold by CMMP or the vermiculite Microlite® sold by W. R. Grace) or modified or treated micas (for example, the Iriodin® range sold by Merck). Mention may be made, as examples of graphites, of the graphites sold by Timcal (Timrex® range). Mention may be made, as examples of talcs, of the talcs sold by Luzenac.

The platy fillers described above are preferably used at a content by volume of preferably between 0% and 50%, more preferably between 1% and 50% and more preferably still between 5% and 50%.

According to a specific embodiment, the content of platy filler in the composition is preferably at least equal to 10% by volume of elastomer composition. Such a content by volume typically corresponds, in view of the average density of the platy fillers used (typically between 2.0 and 3.0) and of that of the TPE elastomers used, to a content by weight of greater than 20 phr, preferably at least equal to 40 phr.

In order to further increase the airtightness of the TPE elastomer layer, use may be made of an even greater content of platy filler, at least equal to 15% by volume, indeed even 20% by volume, which typically corresponds to contents by weight at least equal to 50 phr, indeed even 80 phr. Contents by weight of greater than 100 phr are even advantageously possible.

However, the content of platy filler is preferably less than 50% by volume (typically less than 500 phr), from which upper limit exposure may occur to problems of increase in the modulus, of weakening of the composition, difficulties of dispersion of the filler and of processing, without mentioning a possible negative effect on the hysteresis.

The introduction of the platy fillers into the thermoplastic elastomer composition can be carried out according to various known processes, for example by solution mixing, by bulk mixing in an internal mixer or by extrusion mixing.

I—4. Various Additives

The airtight layer or composition described above can furthermore comprise the various additives normally present in the airtight layers known to a person skilled in the art. Mention will be made, for example, of reinforcing fillers, such as carbon black or silica, non-reinforcing or inert fillers other than the platy fillers described above, colouring agents which can advantageously be used for the colouring of the composition, protection agents, such as antioxidants or antiozonants, UV stabilizers, various processing aids or other stabilizers, or promoters capable of promoting the adhesion to the remainder of the structure of the pneumatic object.

Preferably, the airtight thermoplastic layer of the multilayer laminate does not comprise all these additives at the same time and preferably, in some cases, the multilayer laminate does not comprise any of these agents.

Equally and optionally, the composition of the layers of the multilayer laminate of the invention can comprise a crosslinking system known to a person skilled in the art. Preferably, the composition does not comprise a crosslinking system.

In addition to the elastomers described above, the compositions of the multilayer laminate can also comprise, always according to a minor fraction by weight with respect to the block elastomer, one or more (non-elastomeric) thermoplastic polymers, such as those based on polyether.

II—Composition of the Diene Layer of the Laminate of the Invention

II—1. Thermoplastic Elastomer (TPE)

The second, diene, layer comprises a TPE, always according to a minor fraction of its elastomers.

Thermoplastic elastomers (abbreviated to “TPEs”) have a structure intermediate between elastomers and thermoplastic polymers. These are block copolymers composed of rigid thermoplastic blocks connected via flexible elastomer blocks.

The thermoplastic elastomer used for the implementation of the invention is a block copolymer, the chemical nature of the thermoplastic and elastomer blocks of which can vary.

II—1.1. Structure of the TPE

The number-average molecular weight (denoted Mn) of the TPE is preferably between 30 000 and 500 000 g/mol, more preferably between 40 000 and 400 000 g/mol. Below the minima indicated, there is a risk of the cohesion between the elastomer chains of the TPE being affected, in particular due to its possible dilution (in the presence of an extending oil); furthermore, there is a risk of an increase in the working temperature affecting the mechanical properties, in particular the properties at break, with the consequence of a reduced “hot” performance. Furthermore, an excessively high Mn weight can be damaging to the implementation. Thus, it has been found that a value within a range from 50 000 to 300 000 g/mol is particularly well suited, in particular to use of the TPE in a tyre multilayer laminate composition.

The number-average molecular weight (Mn) of the TPE elastomer is determined in a known way by steric exclusion chromatography (SEC). For example, in the case of thermoplastic styrene elastomers, the sample is dissolved beforehand in tetrahydrofuran at a concentration of approximately 1 g/l and then the solution is filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analytical time is 90 min. A set of four Waters columns in series, with the Styragel tradenames (HMW7, HMW6E and two HT6E), is used. The injected volume of the solution of the polymer sample is 100 μl. The detector is a Waters 2410 differential refractometer, and its associated software, for making use of the chromatographic data, is the Waters Millennium system. The calculated average molar masses are relative to a calibration curve produced with polystyrene standards. The conditions can be adjusted by a person skilled in the art.

The value of the polydispersity index PI (reminder: PI=Mw/Mn, with Mw the weight-average molecular weight and Mn the number-average molecular weight) of the

TPE is preferably less than 3, more preferably less than 2 and more preferably still less than 1.5.

In the present patent application, when reference is made to the glass transition temperature of the TPE, it concerns the Tg relative to the elastomer block. The TPE preferably exhibits a glass transition temperature (“Tg”) which is preferably less than or equal to 25° C., more preferably less than or equal to 10° C. A Tg value greater than these minima can reduce the performance of the multilayer laminate when used at very low temperature; for such a use, the Tg of the TPE is more preferably still less than or equal to −10° C. Preferably again, the Tg of the TPE is greater than −100° C.

In a known way, TPEs exhibit two glass transition temperature peaks (Tg, measured according to ASTM D3418), the lowest temperature being relative to the elastomer part of the TPE and the highest temperature being relative to the thermoplastic part of the TPE. Thus, the flexible blocks of the TPEs are defined by a Tg which is less than ambient temperature (25° C.), while the rigid blocks have a Tg which is greater than 60° C.

In order to be both elastomeric and thermoplastic in nature, the TPE has to be provided with blocks which are sufficiently incompatible (that is to say, different as a result of their respective weights, their respective polarities or their respective Tg values) to retain their own properties of elastomer block or thermoplastic block.

The TPEs can be copolymers with a small number of blocks (less than 5, typically 2 or 3), in which case these blocks preferably have high weights of greater than 15 000 g/mol. These TPEs can, for example, be diblock copolymers, comprising a thermoplastic block and an elastomer block. They are often also triblock elastomers with two rigid segments connected by a flexible segment. The rigid and flexible segments can be positioned linearly, or in a star or branched configuration. Typically, each of these segments or blocks often comprises a minimum of more than 5, generally of more than 10, base units (for example, styrene units and butadiene units for a styrene/butadiene/styrene block copolymer).

The TPEs can also comprise a large number of smaller blocks (more than 30, typically from 50 to 500), in which case these blocks preferably have relatively low weights, for example from 500 to 5000 g/mol; these TPEs will subsequently be referred to as multiblock TPEs and are an elastomer block/thermoplastic block series.

According to a first alternative form, the TPE is provided in a linear form. For example, the TPE is a diblock copolymer: thermoplastic block/elastomer block. The TPE can also be a triblock copolymer: thermoplastic block/elastomer block/thermoplastic block, that is to say a central elastomer block and two terminal thermoplastic blocks, at each of the two ends of the elastomer block. Equally, the multiblock TPE can be a linear series of elastomer blocks/thermoplastic blocks.

According to another alternative form of the invention, the TPE of use for the requirements of the invention is provided in a star-branched form comprising at least three branches. For example, the TPE can then be composed of a star-branched elastomer block comprising at least three branches and of a thermoplastic block located at the end of each of the branches of the elastomer block. The number of branches of the central elastomer can vary, for example, from 3 to 12 and preferably from 3 to 6.

According to another alternative form of the invention, the TPE is provided in a branched or dendrimer form. The TPE can then be composed of a branched or dendrimer elastomer block and of a thermoplastic block located at the end of the branches of the dendrimer elastomer block.

II—1.2. Nature of the Elastomer Blocks

The elastomer blocks of the TPE for the requirements of the invention can be any elastomer known to a person skilled in the art. They generally have a Tg of less than 25° C., preferably of less than 10° C., more preferably of less than 0° C. and very preferably of less than −10° C. Preferably again, the Tg of the elastomer block of the TPE is greater than −100° C.

For the elastomer blocks comprising a carbon-based chain, if the elastomer part of the TPE does not comprise an ethylenic unsaturation, it will be referred to as a saturated elastomer block. If the elastomer block of the TPE comprises ethylenic unsaturations (that is to say, carbon-carbon double bonds), it will then be referred to as an unsaturated or diene elastomer block.

A saturated elastomer block is composed of a polymer sequence obtained by the polymerization of at least one (that is to say, one or more) ethylenic monomer, that is to say a monomer comprising a carbon-carbon double bond. Mention may be made, among the blocks resulting from these ethylenic monomers, of polyalkylene blocks, such as polyisobutylene, polybutylene, polyethylene or polypropylene blocks, or also such as ethylene/propylene or ethylene/butylene random copolymers. These saturated elastomer blocks can also be obtained by hydrogenation of unsaturated elastomer blocks. They can also be aliphatic blocks resulting from the families of the polyethers, polyesters or polycarbonates.

In the case of saturated elastomer blocks, this elastomer block of the TPE is preferably predominantly composed of ethylenic units. Predominantly is understood to mean a content by weight of ethylenic monomer which is the highest, with respect to the total weight of the elastomer block, and preferably a content by weight of more than 50%, more preferably of more than 75% and more preferably still of more than 85%.

Conjugated C₄-C₁₄ dienes can be copolymerized with the ethylenic monomers. They are, in this case, random copolymers. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is chosen from butadiene or isoprene or a mixture comprising butadiene and isoprene.

In the case of unsaturated elastomer blocks, this elastomer block of the TPE is preferably predominantly composed of a diene elastomer part. Predominantly is understood to mean a content by weight of diene monomer which is the highest, with respect to the total weight of the elastomer block, and preferably a content by weight of more than 50%, more preferably of more than 75% and more preferably still of more than 85%. Alternatively, the unsaturation of the unsaturated elastomer block can originate from a monomer comprising a double bond and an unsaturation of cyclic type; this is the case, for example, in polynorbornene.

Preferably, conjugated C₄-C₁₄ dienes can be polymerized or copolymerized in order to form a diene elastomer block. Preferably, these conjugated dienes are chosen from isoprene, butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadine, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1,3-cyclopentadiene, methylcyclopentadiene, 2-methyl-1,6-heptadiene, 1,3-cyclohexadiene, 1-vinyl-1,3-cyclohexadiene or their mixture. More preferably, the conjugated diene is isoprene or butadiene or a mixture comprising isoprene and/or butadiene.

According to an alternative form, the monomers polymerized in order to form the elastomer part of the TPE can be randomly copolymerized with at least one other monomer, so as to form an elastomer block. According to this alternative form, the molar fraction of polymerized monomer, other than an ethylenic monomer, with respect to the total number of units of the elastomer block, has to be such that this block retains its elastomer properties. Advantageously, the molar fraction of this other comonomer can range from 0% to 50%, more preferably from 0% to 45% and more preferably still from 0% to 40%.

By way of illustration, this other monomer capable of copolymerizing with the first monomer can be chosen from ethylenic monomers as defined above (for example ethylene), diene monomers, more particularly the conjugated diene monomers having from 4 to 14 carbon atoms as defined above (for example butadiene), monomers of vinylaromatic type having from 8 to 20 carbon atoms as defined below or also it can be a monomer such as vinyl acetate.

When the comonomer is of vinylaromatic type, it advantageously represents a fraction of units, with regard to the total number of units of the thermoplastic block, from 0% to 50%, preferably ranging from 0% to 45% and more preferably still ranging from 0% to 40%. The styrene monomers mentioned above, namely methylstyrenes, para(tert-butyl)styrene, chlorostyrenes, bromostyrenes, fluorostyrenes or also para-hydroxystyrene, are suitable in particular as vinylaromatic compounds. Preferably, the comonomer of vinylaromatic type is styrene.

According to a preferred embodiment of the invention, the elastomer blocks of the TPE exhibit, in total, a number-average molecular weight (Mn) ranging from 25 000 g/mol to 350 000 g/mol, preferably from 35 000 g/mol to 250 000 g/mol, so as to confer, on the TPE, good elastomeric properties and a mechanical strength which is sufficient and compatible with the use as tyre multilayer laminate.

The elastomer block can also be a block comprising several types of ethylenic, diene or styrene monomers as defined above.

The elastomer block can also be composed of several elastomer blocks as defined above.

II—1.3. Nature of the Thermoplastic Blocks

Use will be made, for the definition of the thermoplastic blocks, of the characteristic of glass transition temperature (Tg) of the rigid thermoplastic block. This characteristic is well known to a person skilled in the art. It makes it possible in particular to choose the industrial processing (transformation) temperature. In the case of an amorphous polymer (or polymer block), the processing temperature is chosen to be substantially greater than the Tg of the thermoplastic block. In the specific case of a semicrystalline polymer (or polymer block), a melting point may be observed which is then greater than the glass transition temperature. In this case, it is instead the melting point (M.p.) which makes it possible to choose the processing temperature for the polymer (or polymer block) under consideration. Thus, subsequently, when reference will be made to “Tg (or M.p., if appropriate)”, this will have to be regarded as the temperature used to choose the processing temperature.

For the requirements of the invention, the TPE elastomers comprise one or more thermoplastic block(s) preferably having a Tg (or M.p., if appropriate) of greater than or equal to 60° C. and formed from polymerized monomers. Preferably, this thermoplastic block has a Tg (or M.p., if appropriate) within a range varying from 60° C. to 250° C. Preferably, the Tg (or M.p., if appropriate) of this thermoplastic block is preferably from 70° C. to 200° C., more preferably from 80° C. to 180° C.

The proportion of the thermoplastic blocks, with respect to the TPE as defined for the implementation of the invention, is determined, on the one hand, by the thermoplasticity properties which the said copolymer has to exhibit. The thermoplastic blocks having a Tg (or M.p., if appropriate) of greater than or equal to 60° C. are preferably present in proportions sufficient to retain the thermoplastic nature of the elastomer of use in the invention. The minimum content of thermoplastic blocks having a Tg (or M.p., if appropriate) of greater than or equal to 60° C. in the TPE can vary as a function of the conditions of use of the copolymer. On the other hand, the ability of the TPE to deform during the preparation of the tyre can also contribute to determining the proportion of the thermoplastic blocks having a Tg (or M.p., if appropriate) of greater than or equal to 60° C.

The thermoplastic blocks having a Tg (or M.p., if appropriate) of greater than or equal to 60° C. can be formed from polymerized monomers of various natures; in particular, they can constitute the following blocks or their mixtures:
polyolefins (polyethylene, polypropylene);
polyurethanes;
polyamides;
polyesters;
polyacetals;
polyethers (polyethylene oxide, polyphenylene ether);
polyphenylene sulphides;
polyfluorinated compounds (FEP, PFA, ETFE);
polystyrenes (described in detail below);
polycarbonates;
polysulphones;
polymethyl methacrylate;
polyetherimide;
thermoplastic copolymers, such as the acrylonitrile/butadiene/styrene (ABS) copolymer.

The thermoplastic blocks having a Tg (or M.p., if appropriate) of greater than or equal to 60° C. can also be obtained from monomers chosen from the following compounds and their mixtures:
acenaphthylene: a person skilled in the art may refer, for example, to the paper by Z. Fodor and J. P. Kennedy, Polymer Bulletin, 1992, 29(6), 697-705;
indene and its derivatives, such as, for example, 2-methylindene, 3-methylindene, 4-methylindene, dimethylindene, 2-phenylindene, 3-phenylindene and 4-phenylindene; a person skilled in the art may, for example, refer to the patent document U.S. Pat. No. 4,946,899, by the inventors Kennedy, Puskas, Kaszas and Hager, and to the documents by J. E. Puskas, G. Kaszas, J. P. Kennedy and W. G. Hager, Journal of Polymer Science Part A: Polymer Chemistry (1992), 30, 41, and J.P. Kennedy, N. Meguriya and B. Keszler, Macromolecules (1991), 24(25), 6572-6577;
isoprene, then resulting in the formation of a certain number of trans-1,4-polyisoprene units and of units cyclized according to an intramolecular process; a person skilled in the art may, for example, refer to the documents by G. Kaszas, J. E. Puskas and J. P. Kennedy, Applied Polymer Science (1990), 39(1), 119-144, and J. E. Puskas, G. Kaszas and J. P. Kennedy, Macromolecular Science, Chemistry A28 (1991), 65-80.

The polystyrenes are obtained from styrene monomers. Styrene monomer should be understood as meaning, in the present description, any monomer comprising styrene, unsubstituted and substituted; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or also para-hydroxystyrene.

According to a preferred embodiment of the invention, the content by weight of styrene in the TPE elastomer is between 5% and 50%. Below the minimum indicated, there is a risk of the thermoplastic nature of the elastomer being substantially reduced while, above the recommended maximum, the elasticity of the multilayer laminate can be affected. For these reasons, the styrene content is more preferably between 10% and 40%.

According to an alternative form of the invention, the polymerized monomer as defined above can be copolymerized with at least one other monomer, so as to form a thermoplastic block having a Tg (or M.p., if appropriate) as defined above.

By way of illustration, this other monomer capable of copolymerizing with the polymerized monomer can be chosen from diene monomers, more particularly conjugated diene monomers having from 4 to 14 carbon atoms, and monomers of vinylaromatic type having from 8 to 20 carbon atoms, such as defined in the part relating to the elastomer block.

According to the invention, the thermoplastic blocks of the TPE exhibit, in total, a number-average molecular weight (“Mn”) ranging from 5000 g/mol to 150 000 g/mol, so as to confer, on the TPE, good elastomeric properties and a mechanical strength which is sufficient and compatible with the use as tyre multilayer laminate.

The thermoplastic block can also be composed of several thermoplastic blocks as defined above.

II—1.4. TPE Examples

For example, the TPE is a copolymer, the elastomer part of which is saturated and which comprises styrene blocks and alkylene blocks. The alkylene blocks are preferably of ethylene, propylene or butylene. More preferably, this TPE elastomer is selected from the following group consisting of diblock or triblock copolymers which are linear or star-branched: styrene/ethylene/butylene (SEB), styrene/ethylene/propylene (SEP), styrene/ethylene/ethylene/propylene (SEEP), styrene/ethylene/butylene/styrene (SEBS), styrene/ethylene/propylene/styrene (SEPS), styrene/ethylene/ethylene/propylene/styrene (SEEPS), styrene/isobutylene (SIB), styrene/isobutylene/styrene (SIBS) and the mixtures of these copolymers.

According to another example, the TPE is a copolymer, the elastomer part of which is unsaturated and which comprises styrene blocks and diene blocks, these diene blocks being in particular isoprene or butadiene blocks. More preferably, this TPE elastomer is selected from the following group consisting of diblock or triblock copolymers which are linear or star-branched: styrene/butadiene (SB), styrene/isoprene (SI), styrene/butadiene/isoprene (SBI), styrene/butadiene/styrene (SBS), styrene/isoprene/styrene (SIS), styrene/butadiene/isoprene/styrene (SBIS) and the mixtures of these copolymers.

For example again, the TPE is a linear or star-branched copolymer, the elastomer part of which comprises a saturated part and an unsaturated part, such as, for example, styrene/butadiene/butylene (SBB), styrene/butadiene/butylene/styrene (SBBS) or a mixture of these copolymers.

Mention may be made, among multiblock TPEs, of the copolymers comprising random copolymer blocks of ethylene and propylene/polypropylene, polybutadiene/polyurethane (TPU), polyether/polyester (COPE) or polyether/polyamide (PEBA).

It is also possible for the TPEs given as example above to be mixed with one another within the layers of the multilayer laminate according to the invention.

Mention may be made, as examples of commercially available TPE elastomers, of the elastomers of SEPS, SEEPS or SEBS type sold by Kraton under the Kraton G name (e.g., G1650, G1651, G1654 and G1730 products) or Kuraray under the Septon name (e.g., Septon 2007, Septon 4033 or Septon 8004), or the elastomers of SIS type sold by Kuraray under the name Hybrar 5125 or sold by Kraton under the name D1161, or also the elastomers of linear SBS type sold by Polimeri Europa under the name Europrene SOLT 166 or of star-branched SBS type sold by Kraton under the name D1184. Mention may also be made of the elastomers sold by Dexco Polymers under the Vector name (e.g., Vector 4114 or Vector 8508). Mention may be made, among multiblock TPEs, of the Vistamaxx TPE sold by Exxon; the COPE TPE sold by DSM under the Arnitel name or by DuPont under the Hytrel name or by Ticona under the Riteflex name; the PEBA TPE sold by Arkema under the PEBAX name; or the TPU TPE sold by Sartomer under the name TPU 7840 or by BASF under the Elastogran name.

Preferably, the TPE elastomer is a thermoplastic block elastomer comprising at least one central polyisobutylene block and adjacent blocks composed of at least one polymerized monomer, other than a styrene monomer, that is to say a TPE-IB-NS as described above for the airtight composition of the laminate.

II—1.5. Amount of TPE

The content of TPE in the second layer (that is to say, the total content, if there are several TPEs) is within a range extending from 5 to less than 50 phr, in particular within a range extending from 5 to 45 phr and more particularly within a range extending from 10 to 40 phr. Below the minimum content of TPE, the adhesive effect is not sufficient whereas, above the recommended maximum, the properties of the diene layer are detrimentally affected to an excessive extent by the strong presence of TPE.

II—2. Diene Elastomer

The composition of the diene layer comprises more diene elastomer(s) than thermoplastic elastomer(s).

Thus, the composition of the diene layer comprises at least one (that is to say, one or more) diene elastomer, which can be used alone or as a blend with at least one (that is to say, one or more) other diene elastomer (or rubber).

“Diene” elastomer or rubber should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

These diene elastomers can be classified into two categories: “essentially unsaturated” or “essentially saturated”.

“Essentially unsaturated” is understood to mean generally a diene elastomer resulting at least in part from conjugated diene monomers having a content of units of diene origin (conjugated dienes) which is greater than 15% (mol %). In the category of “essentially unsaturated” diene elastomers, “highly unsaturated” diene elastomer is understood to mean in particular a diene elastomer having a content of units of diene origin (conjugated dienes) which is greater than 50%.

Thus it is that diene elastomers, such as some butyl rubbers or copolymers of dienes and of α-olefins of EPDM type, can be described as “essentially saturated” diene elastomers (low or very low content of units of diene origin, always less than 15%).

Given these definitions, diene elastomer, whatever the above category, capable of being used in the compositions in accordance with the invention is understood more particularly to mean:
(a)—any homopolymer obtained by polymerization of a conjugated diene monomer having from 4 to 12 carbon atoms;
(b)—any copolymer obtained by copolymerization of one or more conjugated dienes with one another or with one or more vinylaromatic compounds having from 8 to 20 carbon atoms;
(c)—a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d)—a copolymer of isobutene and of isoprene (diene butyl rubber) and also the halogenated versions, in particular chlorinated or brominated versions, of this type of copolymer.

Any type of diene elastomer can be used in the invention. When the composition comprises a vulcanization system, use is preferably made of essentially unsaturated elastomers, in particular of the (a) and (b) types above, in the manufacture of the multilayer laminate according to the present invention.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure, which depends on the polymerization conditions used, in particular on the presence or absence of a modifying and/or randomizing agent and on the amounts of modifying and/or randomizing agent employed. The elastomers can, for example, be prepared in dispersion or in solution; they can be coupled and/or star-branched or else functionalized with a coupling and/or star-branching or functionalization agent. Mention may be made, for example, for coupling to carbon black, of functional groups comprising a C—Sn bond or aminated functional groups, such as benzophenone, for example; mention may be made, for example, for coupling to a reinforcing inorganic filler, such as silica, of silanol functional groups or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973). Mention may also be made, as other examples of functionalized elastomers, of elastomers (such as SBR, BR, NR or IR) of the epoxidized type.

The content of diene elastomer (that is to say, the total content, if there are several of them) in this second layer is between 50 and 95 phr. According to a preferred embodiment of the invention, the content of diene elastomer (that is to say, the total content, if there are several of them) is preferably within a range extending from 55 to 95 phr and more preferably from 60 to 90 phr.

II—3. Nanometric (or Reinforcing) Fillers

The elastomers described above are sufficient in themselves alone for the multilayer laminate according to the invention to be usable; nevertheless, a reinforcing filler can be used in the composition of the diene layer of the laminate of the invention.

When a reinforcing filler is used, use may be made of any type of filler generally used for the manufacture of tyres, for example an organic filler, such as carbon black, an inorganic filler, such as silica, or also a blend of these two types of filler, in particular a blend of carbon black and silica.

When a reinforcing inorganic filler is used, it is possible, for example, to use, in a known way, an at least bifunctional coupling agent (or bonding agent) intended to provide a satisfactory connection, of chemical and/or physical nature, between the inorganic filler (surface of its particles) and the elastomer, in particular bifunctional organosilanes or polyorganosiloxanes.

II—4. Various Additives

The diene layer of the multilayer laminate of the invention can furthermore comprise the various additives normally present in tyre elastomeric layers known to a person skilled in the art. The choice will be made, for example, of one or more additives chosen from protection agents, such as antioxidants or antiozonants, UV stabilizers, the various processing aids or other stabilizers, or promoters capable of promoting the adhesion to the remainder of the structure of the tyre. Equally and preferably, the composition of the diene layer comprises a crosslinking system known to a person skilled in the art.

Optionally again, the composition of the layers of the multilayer laminate of the invention can comprise a plasticizing agent, such as an extending oil (or plasticizing oil) or a plasticizing resin, the role of which is to facilitate the processing of the multilayer laminate, in particular its incorporation in the tyre, by a lowering of the modulus and an increase in the tackifying power.

III—Adhesion of the two layers of the laminate

It has been found that the adhesion of the first layer to the second layer in the laminate of the invention is markedly improved in comparison with the adhesion of a layer of the type of the first layer of the laminate of the invention to a conventional diene layer (that is to say, devoid of thermoplastic elastomer).

This adhesion is expressed by the compatibility of the TPEs present in the layers of the laminate of the invention. Thus, for the requirements of the invention, it is essential for at least 5 phr (and more preferably still 10 phr) of the thermoplastic elastomers present in the second layer to be compatible with at least 5 phr of the thermoplastic elastomers (TPE-IB-NSs) present in the first layer. As indicated above, thermoplastic elastomers are compatible when they exhibit, as a mixture (of these thermoplastic elastomers with one another), a single glass transition temperature or, in the case of semicrystalline thermoplastic blocks, a single melting point for the thermoplastic part of the mixture.

Preferably, at least 5 phr (and more preferably still 10 phr) of the thermoplastic elastomers present in the second layer are compatible with at least 20 phr of the thermoplastic elastomers (TPE-IB-NSs) present in the first layer and more preferably at least 5 phr (and more preferably still 10 phr) of the thermoplastic elastomers present in the second layer are compatible with at least 50 phr of the thermoplastic elastomers (TPE-IB-NSs) present in the first layer.

More preferably, at least 5 phr (and more preferably still 10 phr) of the thermoplastic elastomers present in the second layer are of the same chemical nature as at least 5 phr of the thermoplastic elastomers (TPE-IB-NSs) present in the first layer. TPEs are of the same chemical nature if they comprise thermoplastic blocks comprising the same chemical functional groups (polyesters, polyamides, and the like). Preferably, at least 5 phr (and more preferably still 10 phr) of the thermoplastic elastomers present in the second layer are of the same chemical nature as at least 20 phr of the thermoplastic elastomers (TPE-IB-NSs) present in the first layer and more preferably still at least 5 phr (and more preferably still 10 phr) of the thermoplastic elastomers present in the second layer are of the same chemical nature as at least 50 phr of the thermoplastic elastomers (TPE-IB-NSs) present in the first layer.

Very preferably, at least 5 phr (and more preferably still 10 phr) of the thermoplastic elastomers present in the second layer have thermoplastic blocks identical to the thermoplastic blocks of at least 5 phr of the thermoplastic elastomers (TPE-IB-NSs) present in the first layer. Preferably, at least 5 phr (and more preferably still 10 phr) of the thermoplastic elastomers present in the second layer have thermoplastic blocks identical to the thermoplastic blocks of at least 20 phr of the thermoplastic elastomers (TPE-IB-NSs) present in the first layer and more preferably at least 5 phr (and more preferably still 10 phr) of the thermoplastic elastomers present in the second layer have thermoplastic blocks identical to the thermoplastic blocks of at least 50 phr of the thermoplastic elastomers (TPE-IB-NSs) present in the first layer.

IV—Preparation of the Multilayer Laminate

As indicated above, the multilayer laminate of the invention thus has the essential characteristic of comprising at least two adjacent layers of elastomer:
a first layer, composed of a composition based on at least:
   a thermoplastic block elastomer comprising at least one central polyisobutylene block and adjacent blocks composed of at least one polymerized monomer, other than a styrene monomer, the content of the said thermoplastic block elastomer being within a range extending from more than 50 to 100 phr (parts by weight per 100 parts by weight of elastomer) and it being understood that the glass transition temperature of the said non-styrene polymer constituting the thermoplastic block of the thermoplastic block elastomer is greater than or equal to 60° C. and, in the case of a semicrystalline thermoplastic block, a melting point greater than 60° C.,
   and on a plasticizing system comprising from 1 to 40 phr of a plasticizing oil and from 1 to 40 phr of a hydrocarbon resin, the total content of plasticizer being within a range extending from 2 to 70 phr,
a second layer, composed of a composition based on at least one diene elastomer, the content of diene elastomer being within a range extending from more than 50 to 95 phr, and on at least one thermoplastic elastomer (TPE), the content of thermoplastic elastomer being within a range extending from 5 to less than 50 phr,
it being understood that at least 5 phr of the thermoplastic elastomers present in the second layer are compatible with at least 5 phr of the thermoplastic block elastomers present in the first layer.

The multilayer laminate of the invention is prepared according to methods known to a person skilled in the art, by separately preparing the two layers of the laminate and by then combining the thermoplastic layer with the diene layer, before or after the curing of the latter. The combining of the thermoplastic layer with the diene layer can be carried out under the action of heat and optionally of pressure. The composition of the airtight layer of the laminate of the invention is in this instance particularly suitable for positioning of the said airtight layer after curing of the diene layer of the laminate.

IV—1. First Layer or Airtight Thermoplastic Layer

The airtight thermoplastic layer of the multilayer laminate of the invention is prepared conventionally, for example by incorporation of the various components in a twin-screw extruder, so as to carry out the melting of the matrix and an incorporation of all the ingredients, followed by use of a flat die which makes it possible to produce the thermoplastic layer. More generally, the shaping of the airtight thermoplastic layer can be carried out by any method known to a person skilled in the art: extrusion, calendering, extrusion-blow moulding, injection moulding or cast film.

Preferably, the thermoplastic layer described above has a thickness of greater than 0.05 mm, more preferably of between 0.1 and 10 mm (for example, from 0.2 to 2 mm).

It will be easily understood that, according to the specific fields of application, the dimensions and the pressures involved, the embodiment of the invention can vary, the first airtight layer in fact comprising several preferred ranges of thickness. Thus, for example, for tyres of passenger vehicle type, they can have a thickness of at least 0.3 mm, preferably of between 0.5 and 2 mm. According to another example, for tyres of heavy-duty or agricultural vehicles, the preferred thickness can be between 1 and 3 mm. According to another example, for tyres of vehicles in the field of construction work or for aircraft, the preferred thickness can be between 2 and 10 mm.

IV—2. Second Layer or Diene Layer

The diene layer of the multilayer laminate of the invention is prepared in appropriate mixers, using two successive phases of preparation according to a general procedure well known to a person skilled in the art: a first phase of thermomechanical working or kneading (sometimes referred to as “non-productive” phase) at high temperature, up to a maximum temperature of between 130° C. and 200° C., preferably between 145° C. and 185° C., followed by a second phase of mechanical working (sometimes referred to as “productive” phase) at lower temperature, typically below 120° C., for example between 60° C. and 100° C., during which finishing phase the crosslinking or vulcanization system is incorporated.

According to a preferred embodiment of the invention, all the base constituents of the compositions of the invention, with the exception of the vulcanization system, such as the TPE elastomers or the optional fillers, are intimately incorporated, by kneading, in the diene elastomer during the first “non-productive” phase, that is to say that at least these various base constituents are introduced into the mixer and are thermomechanically kneaded, in one or more stages, until the maximum temperature of between 130° C. and 200° C., preferably of between 145° C. and 185° C., is reached.

By way of example, the first (non-productive) phase is carried out in a single thermomechanical stage during which all the necessary constituents, the optional supplementary covering agents or processing aids and various other additives, with the exception of the vulcanization system, are introduced into an appropriate mixer, such as an ordinary internal mixer. The total duration of the kneading, in this non-productive phase, is preferably between 1 and 15 min. After cooling the mixture thus obtained during the first non-productive phase, the vulcanization system is then incorporated at low temperature, generally in an external mixer, such as an open mill; everything is then mixed (productive phase) for a few minutes, for example between 2 and 15 min.

The final composition thus obtained is subsequently calendered, for example in the form of a layer denoted, in the present invention, diene layer.

IV—3. Preparation of the Laminate

The multilayer laminate of the invention is prepared by combining the airtight thermoplastic layer with the diene layer, before or after curing of the latter. Before curing, this consists in laying the thermoplastic layer on the diene layer, in order to form the laminate of the invention, and in then carrying out the curing of the laminate or of the tyre provided with the said laminate. After curing, the thermoplastic layer is placed on the precured diene layer. In order for the adhesion to be able to be established, a temperature is needed at the interface which is greater than the processing temperature of the TPE, itself greater than the glass transition temperature (Tg) and, in the case of a semicrystalline thermoplastic block, than the melting point (M.p.) of the said TPE, optionally in combination with the application of pressure.

V—Use of the Laminate in a Tyre

The laminate of the invention can be used in any type of tyre. It is particularly well-suited to use in a tyre, tyre finished product or tyre semi-finished product made of rubber, very particularly in a tyre for a motor vehicle, such as a vehicle of two-wheel, passenger vehicle or industrial type, or a non-motor vehicle, such as a bicycle.

The laminate of the invention can be manufactured by combining the layers of the laminate before curing or even after curing. More specifically, as the thermoplastic layer does not require curing, it can be combined with the diene layer of the laminate of the invention before or after the curing of this diene layer, which itself requires curing before being used in a tyre. Thus, the airtight layer of the laminate of the invention can advantageously be assembled with the diene layer of the laminate after manufacture and curing of a tyre incorporating, as final radially internal layer, the diene layer of the laminate of the invention. In this case, the assembling of the two layers of the laminate of the invention is thus subsequent to the manufacture of the tyre incorporating the diene layer of the said laminate.

The multilayer laminate of the invention can advantageously be used in the tyres of all types of vehicles, in particular in the tyres for passenger vehicles capable of running at a very high speed or the tyres for industrial vehicles, such as heavy-duty vehicles.

Such a laminate is preferably positioned on the internal wall of the pneumatic object, covering it completely or at least in part, but it can also be fully incorporated in its internal structure.

In comparison with an ordinary airtight layer based on butyl rubber, the multilayer laminate of the invention has the advantage of exhibiting a markedly lower hysteresis and thus of giving tyres a reduced rolling resistance, by the use of an airtight thermoplastic layer. Furthermore, this airtight thermoplastic layer can be positioned on the diene layer of the laminate after curing of the tyre.

Furthermore, in comparison with the known airtight layers comprising the thermoplastic block elastomer comprising at least one central polyisobutylene block and adjacent blocks composed of at least one polymerized monomer, other than a styrene monomer, the laminate of the invention exhibits the major advantage of adhering to a conventional diene layer, without requiring a specific adhesion layer, since the second layer of the laminate is this conventional layer, in which a fraction of the diene elastomer is replaced with a thermoplastic elastomer (TPE).

1.-35. (canceled)

36. An airtight elastomeric laminate for tires comprising at least two superimposed layers of elastomer:
a first layer comprising at least:
a thermoplastic block elastomer comprising at least one central polyisobutylene block and adjacent blocks composed of at least one non-styrene polymerized monomer,
wherein a content of the thermoplastic block elastomer ranges from more than 50 to 100 phr, and
wherein the glass transition temperature of the non-styrene polymerized monomer constituting a thermoplastic block of the thermoplastic block elastomer is greater than or equal to 60° C. or wherein the melting point of the non-styrene polymerized monomer constituting a semicrystalline thermoplastic block is greater than 60° C., and
a plasticizing system comprising from 1 to 40 phr of a plasticizing oil and from 1 to 40 phr of a hydrocarbon resin,
wherein a total content of the plasticizing system ranges from 2 to 70 phr, and
a second layer comprising:
at least one diene elastomer,
wherein a content of the at least one diene elastomer ranges from more than 50 to 95 phr, and
at least one thermoplastic elastomer,
wherein a content of the at least one thermoplastic elastomer ranges from 5 to less than 50 phr,
wherein at least 5 phr of the at least one thermoplastic elastomer present in the second layer are compatible with at least 5 phr of the thermoplastic block elastomer present in the first layer.

37. The airtight elastomeric laminate according to claim 36, wherein the number-average molecular weight of the thermoplastic block elastomer is between 30,000 and 500,000 g/mol.

38. The airtight elastomeric laminate according to claim 36, wherein thermoplastic blocks of the thermoplastic block elastomer are selected from the group consisting of polyolefins, polyurethanes, polyamides, polyesters, polyacetals, polyethers, polyphenylene sulphides, polyfluorinated compounds, polystyrenes, polycarbonates, polysulphones, polymethyl methacrylate, polyetherimide, thermoplastic copolymers and mixtures thereof.

39. The airtight elastomeric laminate according to claim 36, wherein the content of the thermoplastic block elastomer ranges from 70 to 100 phr.

40. The airtight elastomeric laminate according to claim 39, wherein the content of the thermoplastic block elastomer ranges from 80 to 100 phr.

41. The airtight elastomeric laminate according to claim 40, wherein the thermoplastic block elastomer is the only elastomer of the first layer.

42. The airtight elastomeric laminate according to claim 36, wherein the plasticizing system comprises from 2 to 30 phr of the plasticizing oil.

43. The airtight elastomeric laminate according to claim 42, wherein the plasticizing system comprises from 5 to 20 phr of the plasticizing oil.

44. The airtight elastomeric laminate according to claim 36, wherein the plasticizing oil is selected from the group consisting of polyolefinic oils, paraffinic oils, naphthenic oils, aromatic oils, mineral oils and mixtures thereof.

45. The airtight elastomeric laminate according to claim 44, wherein the plasticizing oil is a polybutene oil.

46. The airtight elastomeric laminate according to claim 45, wherein the plasticizing oil is a polyisobutylene oil.

47. The airtight elastomeric laminate according to claim 36, wherein the plasticizing system comprises from 2 to 30 phr of hydrocarbon resin.

48. The airtight elastomeric laminate according to claim 47, wherein the plasticizing system comprises from 5 to 20 phr of hydrocarbon resin.

49. The airtight elastomeric laminate according to claim 36, wherein the hydrocarbon resin is selected from the group consisting of cyclopentadiene or dicyclopentadiene homopolymer or copolymer resins, terpene homopolymer or copolymer resins, terpene/phenol homopolymer or copolymer resins, C₅ fraction homopolymer or copolymer resins, C₉ fraction homopolymer or copolymer resins, α-methylstyrene homopolymer or copolymer resins and mixtures thereof.

50. The airtight elastomeric laminate according to claim 49, wherein the hydrocarbon resin is selected from the group consisting of copolymer resins of two different vinylaromatic monomers, (D)CPD/vinylaromatic, (D)CPD/terpene copolymer resins, (D)CPD/C₅ fraction copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins and mixtures thereof.

51. The airtight elastomeric laminate according to claim 50, wherein the hydrocarbon resin is selected from the group consisting of (D)CPD homopolymer resins, (D)CPD/styrene copolymer resins, polylimonene resins, limonene/styrene copolymer resins, limonene/D(CPD) copolymer resins, C₅ fraction/styrene copolymer resins, C₅ fraction/C₉ fraction copolymer resins, styrene/α-methylstyrene copolymer resins and mixtures thereof.

52. The airtight elastomeric laminate according to claim 51, wherein the hydrocarbon resin is a styrene/α-methylstyrene copolymer resin.

53. The airtight elastomeric laminate according to claim 36, wherein the total content of plasticizer ranges from 5 to 45 phr.

54. The airtight elastomeric laminate according to claim 53, wherein the total content of plasticizer ranges from 10 to 35 phr.

55. The airtight elastomeric laminate according to claim 36, wherein the first layer further comprises a platy filler.

56. The airtight elastomeric laminate according to claim 36, wherein the first layer does not comprise a crosslinking system.

57. The airtight elastomeric laminate according to claim 36, wherein the number-average molecular weight of the at least one thermoplastic elastomer is between 30,000 and 500,000 g/mol.

58. The airtight elastomeric laminate according to claim 36, wherein elastomer blocks of the at least one thermoplastic elastomer are chosen from elastomers having a glass transition temperature of less than 25° C.

59. The airtight elastomeric laminate according to claim 36, wherein elastomer blocks of the at least one thermoplastic elastomer are selected from the group consisting of ethylenic elastomers, diene elastomers and mixtures thereof.

60. The airtight elastomeric laminate according to claim 36, wherein elastomer blocks of the at least one thermoplastic elastomer are chosen from ethylenic elastomers.

61. The airtight elastomeric laminate according to claim 36, wherein elastomer blocks of the at least one thermoplastic elastomer are chosen from diene elastomers.

62. The airtight elastomeric laminate according to claim 36, wherein thermoplastic or semicrystalline thermoplastic blocks of the at least one thermoplastic elastomer are chosen from polymers having a glass transition temperature of greater than 60° C. and polymers having a melting point of greater than 60° C.

63. The airtight elastomeric laminate according to claim 36, wherein thermoplastic blocks of the at least one thermoplastic elastomer are selected from the group consisting of polyolefins, polyurethanes, polyamides, polyesters, polyacetals, polyethers, polyphenylene sulphides, polyfluorinated compounds, polystyrenes, polycarbonates, polysulphones, polymethyl methacrylate, polyetherimide, thermoplastic copolymers and mixtures thereof.

64. The airtight elastomeric laminate according to claim 36, wherein the content of the at least one thermoplastic elastomer ranges from 5 to 45 phr.

65. The airtight elastomeric laminate according to claim 64, wherein the content of the at least one thermoplastic elastomer ranges from 10 to 40 phr.

66. The airtight elastomeric laminate according to claim 36, wherein the at least one diene elastomer is selected from the group consisting of essentially unsaturated diene elastomers and mixtures thereof.

67. The airtight elastomeric laminate according to claim 66, wherein the at least one diene elastomer is selected from the group consisting of the homopolymers obtained by polymerization of a conjugated diene monomer having from 4 to 12 carbon atoms, the copolymers obtained by copolymerization of one or more conjugated dienes with one another or with one or more vinylaromatic compounds having from 8 to 20 carbon atoms, and mixtures thereof.

68. The airtight elastomeric laminate according to claim 67, wherein the at least one diene elastomer is selected from the group consisting of polybutadienes, synthetic polyisoprenes, natural rubber, butadiene copolymers, isoprene copolymers and mixtures thereof.

69. The airtight elastomeric laminate according to claim 36, wherein the second layer further comprises a reinforcing filler.

70. The airtight elastomeric laminate according to claim 69, wherein the reinforcing filler is carbon black, silica, or a mixture thereof.

71. The airtight elastomeric laminate according to claim 70, wherein the predominant reinforcing filler is carbon black.

72. A tire comprising the airtight elastomeric laminate according to claim 36.

73. A pneumatic object comprising the airtight elastomeric laminate according to claim 36.
